(19) United States
(12) Patent Application Publication
(10) Pub. No.: US 2018/0322514 A1
(43) Pub. Date: Nov. 8, 2018

(54) UNIQUELY IDENTIFIABLE CUSTOMER TRAFFIC SYSTEMS AND METHODS

(71) Applicant: Walmart Apollo, LLC, Bentonville, AR (US)

(72) Inventors: Matthew Jason Sargent, Bentonville, AR (US); Christopher S. Johnson, Pea Ridge, AR (US); Lori K. Bruni, Centerton, AR (US)

(21) Appl. No.: 15/972,743

(22) Filed: May 7, 2018

Related U.S. Application Data
(60) Provisional application No. 62/502,918, filed on May 8, 2017.

(51) Int. Cl. G06Q 30/02; G06Q 20/20

(52) U.S. Cl. CPC G06Q 30/0201; G06Q 20/20

(57) ABSTRACT

Embodiments relate to systems and methods for customer singulation in a defined retail environment. A customer singulation system can include a sensor matrix, a POS system, and a customer singulation engine. The sensor matrix includes a plurality of fixed sensors arranged in the defined retail environment and at least one mobile sensor configured to move within the defined retail environment. The plurality of fixed sensors and the at least one mobile sensor are configured to obtain sensor data by remotely and non-intrusively sensing a common characteristic of a plurality of customers in the defined retail environment. The POS system is located in the defined retail environment and is configured to receive customer data from the plurality of customers as part of a retail purchase transaction. The customer singulation engine is configured to receive the sensor data and the customer data and singulate at least one of the plurality of customers.

### RELATED APPLICATION

The present application claims the benefit of U.S. Provisional Application No. 62/502,918 filed May 8, 2017, which is hereby incorporated herein in its entirety by reference.

### TECHNICAL FIELD

Embodiments relate generally to non-intrusive customer behavior identification and more particularly to identifying customer movement in retail stores using non-intrusive identification techniques.

### BACKGROUND

Various retail, wholesale and membership-based stores and businesses (referred to herein generally as defined retail stores or environments) routinely strive to better understand interactions of customers in their stores so that customer visiting and purchasing experiences can be improved. However, obtaining information about actual customer movements and tendencies in stores has been challenging, and compiling useful and comprehensive data related to purchasing decisions has been difficult.

In general, stores have desired to arrange their retail spaces in ways that enable customers to find items they seek and identify complementary helpful items while also making store visits efficient. To accomplish this, store layouts are planned and analyzed at many levels, from the relative arrangement of departments to the particular placement of individual products.

Store layouts and item placements are reviewed on an ongoing basis in order to determine the placement of new products or reposition existing products that customers have been unable to find or that could benefit from a new location (e.g., arranging cross-category products adjacent one another to make item location and shopping more convenient and efficient for customers). Similarly, stores have tried, with limited success, to compile data to help understand which areas of the store are most visited, provide the most effective customer exposure to products, and require modification to maximize customer experiences and purchasing efficiencies.

Conventional techniques include monitoring paths taken by customers through stores via an app on a customer's mobile phone or device. However, requiring use of a customer mobile phone or device with an active app likely limits monitoring to only a small cross-section of customers who are willing to use their mobile device to do this, even if incentivized. Other monitoring technologies have been proposed that involve determining customer identities. However, utilizing a customer's identity is something that can be objectionable to some customers who are uncomfortable with potentially intrusive monitoring for privacy reasons.

Despite past efforts, stores continue to struggle to precisely understand the correlation between customer movement in retail spaces, product location and purchase data. Accordingly, the ability to compile information about customer movements and purchases would be extremely useful data for analysis. Such analysis could help stores enhance customer experiences and increase sales. Therefore, new effective systems and methods of obtaining and analyzing customer movement data and purchase data in a retail environment by non-intrusive methods are needed.

### SUMMARY

In an embodiment, a customer singulation system for use in a defined retail environment includes a sensor matrix, a point-of-sale (POS) system, and a customer singulation engine. The sensor matrix includes: a plurality of fixed sensors arranged in the defined retail environment; and at least one mobile sensor configured to move within the defined retail environment. The plurality of fixed sensors and the at least one mobile sensor are configured to obtain sensor data by remotely and non-intrusively sensing a common characteristic of a plurality of customers in the defined retail environment. The POS system is located in the defined retail environment and is configured to receive customer data from the plurality of customers as part of a retail purchase transaction. Further, each retail purchase transaction has a time stamp and a location. The customer singulation engine is configured to receive the sensor data and the customer data, singulate at least one of the plurality of customers by matching the time stamp and the location with corresponding sensor data, and match the singulated customer with corresponding received customer data.

In an embodiment, a method of singulating customers in a defined retail environment comprises arranging a sensor matrix including: a plurality of fixed sensors and at least one mobile sensor in the defined retail environment; obtaining sensor data by the sensor matrix by remotely and non-intrusively sensing a common characteristic of a plurality of customers in the defined retail environment; obtaining customer data from the plurality of customers as part of retail purchase transactions at a point-of-sale (POS) system in the defined retail environment, each retail purchase transaction comprising a time stamp and a location; and receiving the sensor data and the customer data by a customer singulation engine configured to singulate at least one of the plurality of customers by matching the time stamp and the location with corresponding sensor data, and matching the singulated customer with corresponding received customer data.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a customer singulation system in a defined retail environment according to an embodiment.

FIG. 2 is a schematic diagram of a defined retail environment equipped with a sensor matrix and POS system according to an embodiment.

FIG. 3 is a block diagram of a customer singulation system including inputs to a customer singulation engine according to an embodiment.

FIG. 4 is a flowchart of a method of singulating customers in a defined retail environment according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments relate to systems and methods for singulating customers in a defined retail environment. Embodiments of systems and methods discussed herein can be used in many ways, including providing accurate identification of customer movements and purchases using non-intrusive technologies and procedures. Embodiments use limited identifying information to provide data for store analytics related to a customer entering a defined retail environment, moving around the defined retail environment, and making a purchase in the defined retail environment. Store analytics can then be used to enhance customer experiences and convenience in the future and, in turn, increase sales and satisfaction from future customers.

References to “customer singulation” and various similar forms of this term, as used throughout this disclosure, are intended to refer generally to concepts involving actions by which individual customers and their associated data are identified and distilled from a larger group of customers and data.

The retail stores or environments in which these systems and methods can be used include virtually any retail outlet, including a physical, brick-and-mortar storefront; or some other setting or location via which a customer may purchase or obtain products. In some embodiments, the retail environment is a wholesale club or other membership-based retail environment for which customer-members have membership cards or other required identifying information. Though only a single defined retail environment may be discussed in examples used herein, in many cases the systems and methods can include a plurality of retail environments. For example, data from one or a plurality of retail environments can be aggregated, analyzed and applied to one or a plurality of other retail environments. In some embodiments, data from one or a plurality of retail environments can be aggregated, analyzed and/or applied in conjunction with data related to online shopping behaviors, patterns or other factors.

The defined retail environment can be associated with a retailer, such as by being a subsidiary, franchise, owned outlet, or other affiliate of the retailer. The retailer can be or have a home office or headquarters of a company, or some other affiliate, which often is located apart from the defined retail environment itself. In some embodiments, facilities or functions associated with the broader retailer can be partially or fully co-located with the defined retail environment. For example, the retailer and a brick-and-mortar retail environment can be co-located. At times in this application, the terms “store,” “retailer,” “retail environment” and “defined retail environment” are used interchangeably. These terms should generally be broadly construed in a non-limiting manner.

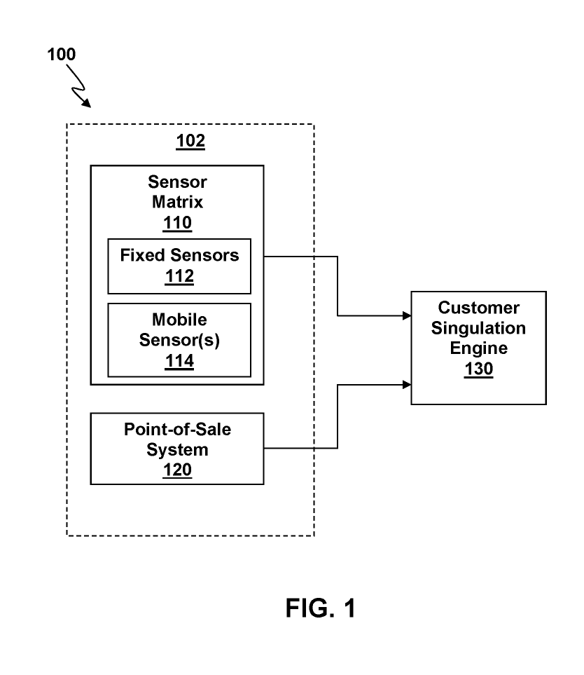

Referring to FIGS. 1-3, embodiments of a customer singulation system 100 for use in a defined retail environment 102 are depicted. As shown in FIG. 1, customer singulation system 100 comprises a sensor matrix 110, a POS system 120 and a customer singulation engine 130. In embodiments, the sensor matrix 110 and point-of-sale system 120 are co-located in a defined retail environment 102.

Sensor matrix 110 generally comprises a plurality of fixed sensors 112 arranged at various locations throughout the defined retail environment 102 as well as one or more mobile sensors 114 that are configured to move within the defined retail environment 102. Fixed sensors may include infrared sensors, optical sensors, temperature sensors, pressure sensors, or other potentially non-intrusive sensors. Fixed sensors 112 such as infrared sensors may be located at various sites in a store or other defined retail environment 102. This may include mounting at a store entrance 104, in locations above or in various aisles 105 or shelves 106, on the walls 107, on the ceiling or fixtures, or any other suitable site. In some embodiments, a fixed sensor 112 is mounted proximate to each lane of the POS system 120 and a fixed sensor 112 is mounted proximate each entrance or exit of the defined retail environment 102. Fixed sensors 112, such as pressure or temperature sensors, also or alternatively can be mounted or arranged in the floor or walking surfaces of retail environment 102.

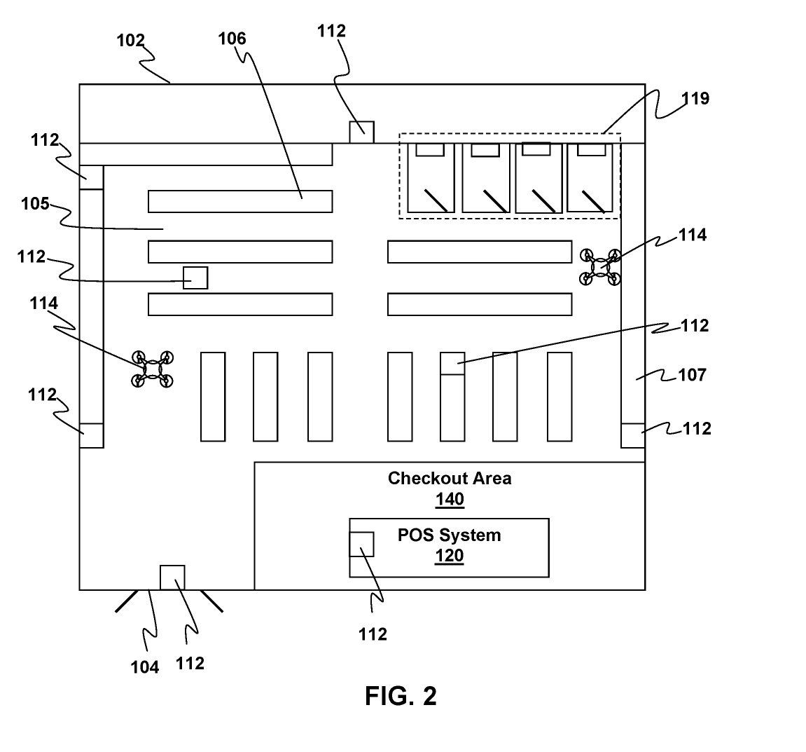

Mobile sensors 114 may be infrared sensors, optical sensors, temperature sensors, pressure sensors, or other potentially non-intrusive sensors. Mobile sensors 114 may be mounted on or in an unmanned aerial vehicle, drone, robot, ceiling structure or substructure, or floor structure. FIG. 2 shows two mobile sensors 114 depicted as unmanned aerial vehicles.

Mobile sensors 114, such as unmanned aerial vehicles, are advantageous as they can lack blindspots that are present in sensors like fixed sensors 112. In some cases, mobile sensors 114 will be less expensive than fixed sensors 112 and will not be as restricted by a fixed line-of-sight. In some embodiments, fixed sensors 112 are located near the doors of a defined retail environment 102 and the mobile sensors 114 move throughout the interior of the defined retail environment 102.

Both the fixed sensors 112 and the mobile sensors 114 are configured to obtain sensor data 115 by remotely and non-intrusively sensing a common characteristic of customers in a defined retail environment 102. Characteristics of customers are remotely sensed to obtain sensor data 115 as the data is largely obtained without requiring sensors contacting or being in the immediate vicinity of a customer and can be analyzed at another location. Characteristics of customers are non-intrusively sensed to obtain sensor data 115 as customer paths are identified by a characteristic that can be associated with a particular customer for limited purposes during a specific individual store visit, such as identifying paths or movements and purchases of a generic individual, without compromising details regarding that individual's actual identity.

Possible common characteristics of customers that can be sensed include: infrared radiation characteristics; thermal characteristics; or physical characteristics. For example, in one case, an infrared beam (IRB) can identify the unique infrared radiation or thermal properties of each customer and use these properties to identify movement through the store. As each customer possesses unique infrared radiation and thermal properties, every one of the customers in the store can be simultaneously and individually identified, or singulated. Likewise, in another case, temperature sensors can identify the unique heat characteristics of each customer and use these properties to identify movement through the store.

In still other cases, a common characteristic of customers could relate to sensing a pressure and pattern of footsteps of an individual. Pressure sensors built into the floor, for example, could be adapted to recognize the path of an individual and the pressure exerted on the floor surface of that individual during movement. In some embodiments, a mechanism in the floor could be deemed a mobile sensor 114. In other embodiments, pressure sensors in the floor can be considered fixed sensors 112 which could be used in cooperation with mobile sensor(s) 114, such as unmanned aerial vehicles.

In other cases, a physical characteristic could be used to identify and follow or document movement. This physical characteristic could be based on electronic identification of the customer using biometric information, such as fingerprints, voice recognition, facial recognition, etc. Particularly, in cases where biometric information is used, records of this biometric data can be masked such that it cannot be used for actual name identification of customers in the store. In some cases, optical recognition technologies are used that provide facial or body recognition with limited resolution or biometric information in order to help preserve customer privacy. In some situations, customer consent may be obtained for individual identification, such as for research or other purposes, or incentives.

While common characteristic identification of a customer is on-going, additional sensors, such as optical sensors (which can be fixed sensors 112 and/or mobile sensors 114) can be used for sensing data in the store related to this customer and his or her activities. For example, optical recognition or other techniques can be used to identify products viewed by the customer in the store.

Sensor data 115, obtained from fixed sensors 112 and mobile sensors 114, may include: locations 116, time stamps 117, the route a customer takes within a store, the amount of time spent in a particular isle or near a particular product, the total time of the visit, and the identities of the products viewed or handled.

Referring also to FIG. 2, in embodiments, the sensor matrix 110 includes fixed sensors 112 proximate to an entrance to a defined retail environment 102 to electronically initially identify a customer's presence in the retailer as the customer enters automatically (e.g., via wireless technology). In other embodiments, a sensor matrix 110 is arranged or otherwise configured to initially detect or determine a customer's presence in or at another location in the retailer. As mentioned earlier, fixed sensors 112 may be readily mounted at or on a store entrance 104, aisles 105, shelves 106, walls 107, the ceiling, or fixtures.

In some embodiments, the defined retail environment 102 can be confined by a particular geofence setting the limits for identifying customers. In certain embodiments, a sensor-free zone 119 may be present in the defined retail environment 102. The sensor-free zone 119 is constructed so that it and the sensor matrix 110 do not overlap in a physical or aerial space. A sensor free zone 119 of this type can be used to define the area around fitting rooms, restrooms, or other areas in which customers have a greater expectation and desire for privacy. Depending upon the sensors used, measures such as a Faraday cage or other feature to block unwanted monitoring could be implemented at these sensor-free zones 119.

In operation, as a customer moves through a store, the sensor matrix 110 senses a characteristic of the customer in a non-intrusive way and records sensor data 115, such as a location 116, a time stamp 117, or other information and associates it with that customer. In some embodiments, sensor matrix 110 can comprise memory and a database in which to store the customer and sensor data 115. In other embodiments, the sensor data 115 is communicated by the sensor matrix 110 to customer singulation engine 130. This communication can be wireless, wired, or transferred in another way (e.g., by an employee of the retailer downloading batch data from sensor matrix 110 periodically and transferring the data in some way to customer singulation engine 130).

After moving through the defined retail environment 102 and having movements detected and monitored by sensor matrix 110, the customer takes a final path as he or she completes the shopping trip. The customer takes the assembled items to checkout area 140 to make a purchase via POS system 120.

POS system 120 can comprise or be communicatively coupled with the cash register computer system in retailer 102 (and/or an online payment system for retailers having web-based stores) in order to provide information about purchases made by customers in or from retailer 102. The POS system 120 in the store is configured to receive customer data 124 from customers as part of a retail purchase transaction 122. Customer data 124 can include a name, an address, a member identifier, a loyalty program identifier, a telephone number, or an email address. In some cases, customer data 124 may include a cash transaction identifier. This identifying information can be gleaned from “traceable tender,” such as credit cards, loyalty programs, or membership data. One advantage of the type of identification and customer singulation described in this application is the ability to identify in-store movements of customers that pay with cash and do not provide other identifying information or traceable tender. These cash-paying customers would otherwise represent customer data that is difficult to analyze. In some cases, even if a cash-paying customer is not individually recognized, aggregate data regarding these individuals can be useful for analysis.

Retail purchase transactions can include various methods of payment and recordation of information pertaining to the purchased products and customer. The retail purchase transaction 122 further has a location 126 and a time stamp 128 in most instances. The location of the retail purchase transaction 122 can include a POS lane number or a POS system registration number in some embodiments.

In membership-based retail or other business, customers typically must provide a membership card or other identification information at the time of making purchases, similar to as discussed above to identify the customer-members by or at customer identification module. This can enable system 100 to link information about customer visits to or presence at retailer 102 with purchases made at or from retailer 102, including purchases made during particular visits. Additionally, customer check-out via POS system 120 can provide a timestamp associated with customer presence at POS system 120 so that system 100 can determine an approximate length of customer visit to retailer 102 from the first timestamp from sensor matrix 110 and the timestamp at POS system 120 at checkout. In still other embodiments, the sensor matrix 110 can comprise an additional unit at POS system 120 or proximate an exit of retailer 102 to determine when a customer is leaving retailer 102. This can be helpful when customers do not make purchases and so do not interact with POS system 120.

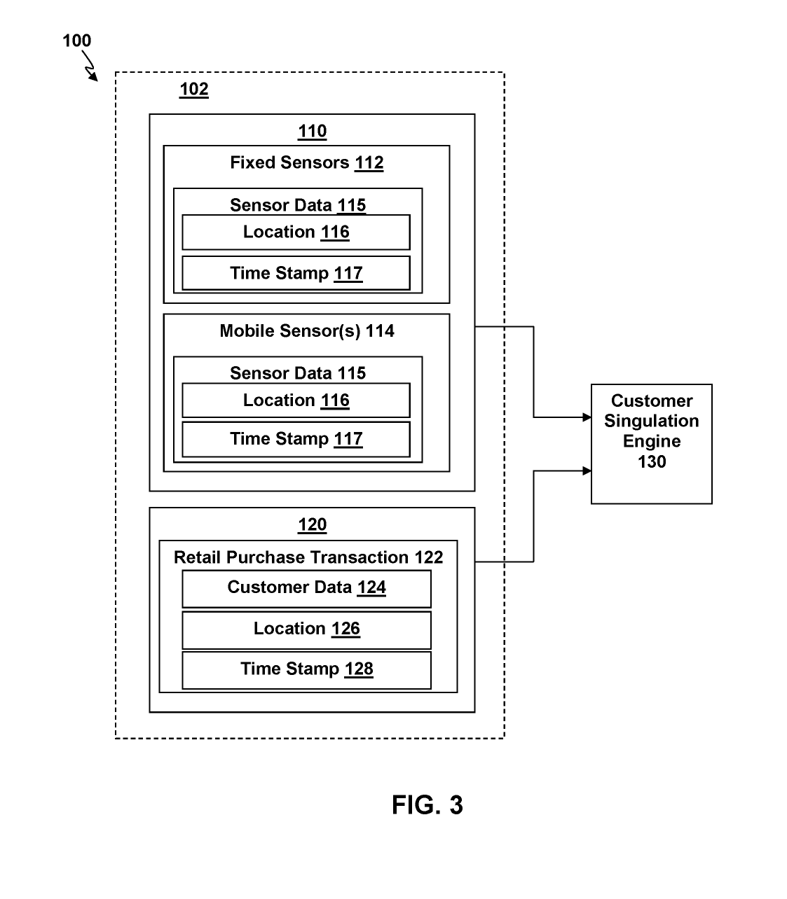

Referring to FIG. 3, the overall customer singulation system 100 can be more fully understood. Once a customer has completed a visit to retailer 102, a characteristic has been identified and corresponding sensor data 115, including time stamps 117 and locations 116, have been obtained by the sensor matrix 110 and POS system 120. Specifically, the sensor matrix 110 obtains a plurality of sensor data 115 starting in time from a first record of sensor data 115 and continuing on through a plurality of intermediate records of sensor data 115, each having its own time stamp. Finally, a final record of sensor data 115 is obtained at the POS system 120 with a time stamp as well. In some embodiments, a fixed sensor 112 is mounted proximate to each lane of the POS system 120 to receive this final record. In the context of the example of FIG. 2, system 100 knows when a customer having a particular characteristic was at locations monitored by the sensor matrix 110 throughout the store and checkout area 140 (via interaction with POS system 120).

Once at the POS system 120, a retail purchase transaction 122 is completed. This may occur at a checkout aisle, for example. The POS system 120 is configured to receive customer data 124 from customers as part of the retail purchase transaction 122. Each retail purchase transaction 122 includes a location 126 (e.g., an aisle or lane number) and time stamp 128 as well.

These data elements, comprising both sensor data 115 and customer data 124, are communicated to or otherwise received by customer singulation engine 130, which is communicatively coupled with sensor matrix 110 and POS system 120 in embodiments. The customer singulation engine 130 is then able to singulate customers by matching a location 126 and time stamp 128 of the retail purchase transaction 122 with corresponding sensor data 115 and matching the singulated customer with corresponding received customer data 124.

In some embodiments, customer singulation engine 130 is located remote from retailer 102 (e.g., at a home office) and can be communicatively coupled with multiple locations of retailer 102. In other embodiments, customer singulation engine 130 is co-located, at least in part, at retailer 102. In still other embodiments, some or all of sensor matrix 110, POS system 120 and customer singulation engine 130 are coupled with or form part of a cloud-based computing environment. A cloud-based computing environment can comprise one in which data is stored on one or more physical servers that can be located in one or more locations. The one or more locations typically, but not necessarily, are remote from the data sources (e.g., system 100 and/or retailer 102). The servers and other hardware and software associated with the cloud-based system can be owned by retailer 102 or by an external company, such as a hosting company, from which retailer 102 buys or rents storage space. In embodiment, the cloud-based or some other suitable storage system comprising a database can store information related to purchased items, purchased item locations, and customer interaction points and timestamps. This information can be concatenated in a database entry, stored together in logical pools, or arranged in the database in some other suitable form.

In embodiments, the data obtained by customer singulation engine 130 can be used to suggest a change of physical location of at least one item in the retail store to optimize physical layout of retailer 102, determine a location of a new item to be added to retailer 102, determine a layout of a new retailer 102, and/or to make another determination or change related to retailer 102. These suggestions can be provided in a variety of ways. For example, system 100 can generate an instruction to an associate at retailer 102 to add one item to another item's location. This instruction can be provided electronically, such as via a computer or other electronic device used by the associate in his or her day-to-day work. This instruction also can be provided manually, such as in a report or diagram related to a portion of retailer 102. In another example, system 100 can provide an updated or new design for a particular shelf of modular design, which could also be provided to an associate electronically or manually at retailer 102. In a particular example, system 100 can generate a visual of a particular modular design with images of products and placement for an associate to replicate in retailer 102.

The suggestions made possible by customer singulation engine 130 can be permanent or temporary. For example, customer singulation engine 130 can suggest locating a special product display in a particular area between 3-7 pm because customer paths often pass that area, and customers may be seeking ideas for preparing an evening meal. The suggestions of customer singulation engine 130 can be applied to the same retailer 102 in which the data was obtained or other retailers. For example, two locations of retailer 102 may share similar customer demographic or other characteristics, such that data from the first location, either originally or after showing success, can be applied at the second location. The same is true for a new location to be opened, with data relating to item location or layout from an existing location used to determine item location or layout of the new location.

Customer singulation engine 130 also can aggregate data for a particular customer or pluralities of customers. For example, customer singulation engine 130 can determine that one customer frequently buys the same items on different visits. If that customer purchases a new item on one visit and the visit time is significantly longer than is usual for that customer, customer singulation engine 130 may determine that the customer had difficulty locating the new item because it is not in a convenient or intuitive location. Relocation of that item could be suggested. In another example, customer singulation engine can compare data for two customers who shop at two different retailers 102 but purchase similar items. The data of one customer may show that that customer's location has a preferred layout, which can be determined by correlating the data between the customers, creating path maps from the data points, and comparing the maps to compare conditions, arrangements and other factors between the two locations.

In embodiments, customer singulation engine 130 can make specific suggestions based on the data and analysis. In other embodiments, customer singulation engine 130 can additionally consider manual input from an analyst user. In these embodiments, system 100 can further comprise a user interface (not depicted) communicatively coupled with customer singulation engine 130. Via this user interface, a user can input additional data, criteria, or other information, and receive and interact with analysis, maps, data and other information from customer singulation engine 130 and system 100 as a whole.

In general, however, the amount and type of data managed, processed and analyzed by customer singulation engine 130 and system 100 is outside the capabilities of manual processing and beyond mere automation of tasks that have been or could be performed by hand. In particular, system 100 can access huge volumes of data, relating to thousands or millions of customers/customer visits and hundreds or thousands of retailers. This data can relate to data collected over time (e.g., weeks, months or even years) for millions of items and locations. The hardware and software components of system 100 can analyze, correlate and transform this data into the meaningful result of a physical change of an item location or retailer layout, among other things. The particular configuration of sensors used in embodiments, and the particular methods of using the raw data from the sensors (both alone, and in combination with other data) enable embodiments to more accurately calculate and correlate customer movements and behaviors.

Going forward, data related to relocated items, newly located items or new layouts of retailer 102 can be analyzed for continuous improvement on-site or application of the same or similar changes at other locations of retailer 102. In some embodiments, customer singulation engine 130 can provide suggestions for temporary (e.g., seasonal) item locations based on data from particular time periods or seasons in past years. More generally, customer singulation engine 130 and system 100 can be used to proactively locate and even relocate items and groups of items to improve customer experience, retailer sales, and other real-world benefits.

These and other advantages can be achieved with improved customer comfort as the actual identities of customers, including names or likenesses, are not determined in stores, which can make some uncomfortable. Additionally, some past systems rely on using customer devices (e.g., smartphones, tablets) which are not necessary here.

Yet another advantage can be integration of system 100 with employee incentive and other programs. For example, an additional sensor matrix 110 can be located at a product demonstration location, a product sampling location, an item display location, an in-store amenity location, a staffed location, or a service location so that customers can or must check in before interacting with these locations. For example, if the location is a product demonstration or sampling location, the customer must check in at the additional sensor matrix 110 before receiving a sample. Data from matrix sensors 110 (including a time stamp of the customer check-in) can be included or correlated with customer path and purchase information to determine the effectiveness of the demonstration, its personnel, the item, and its location. This, in turn, can be used to provide rewards to product demonstration personnel when customers purchase the demonstrated items or to determine where, when and/or which items to demonstrate in the future. Demonstrated item purchase data can be correlated with other customer purchases to identify complementary or other items, which then can be used for location and other analytics.

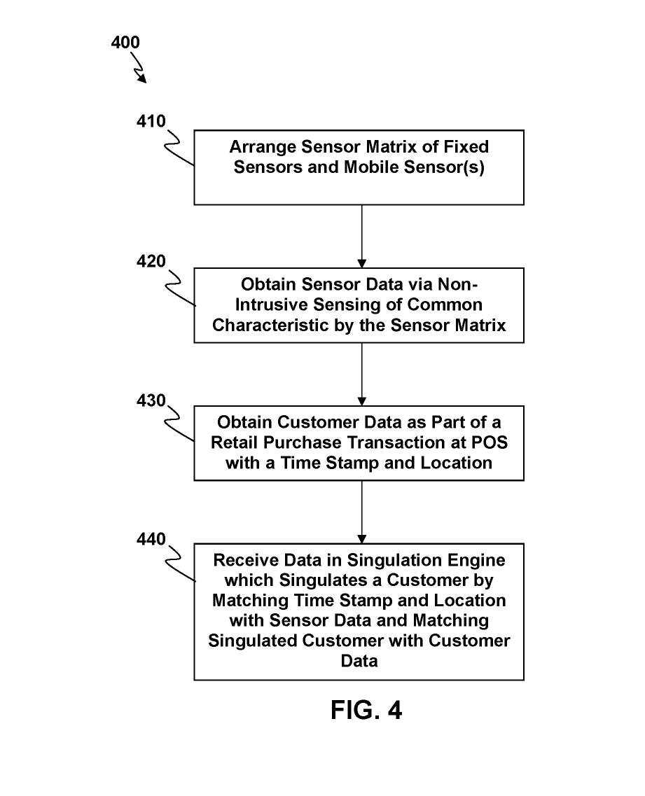

Referring to FIG. 4, a flowchart of one embodiment of a method 400 of singulating customers in a defined retail environment, related to system 100, is depicted. At 410, a sensor matrix 110 is arranged in a defined retail environment 102. The sensor matrix 110 includes a plurality of fixed sensors 112 and at least one mobile sensor 114. The plurality of fixed sensors 112 and the at least one mobile sensor 114 include at least optical sensors, infrared sensors, temperature sensors or pressure sensors. Arranging the sensor matrix 110 can include configuring at least one mobile sensor 114 on an unmanned aerial vehicle. Arranging the sensor matrix 110 can include mounting the plurality of fixed sensors 112 on a floor, a wall 107, a ceiling, or a fixture in the defined retail environment 102. In some cases this includes mounting a fixed sensor 112 to each lane of the POS system 120 and mounting at least one fixed sensor 112 proximate to each entrance 104 or exit of the defined retail environment 102.

Next, at 420, once a customer enters the defined retail environment 102, sensor data 115 is obtained by the sensor matrix 110 by remotely and non-intrusively sensing a common characteristic of a plurality of customers in the defined retail environment 102. The sensing a common characteristic can refer to sensing a physical characteristic, an infrared radiation characteristic, or a thermal characteristic.

At 430, customer data 124 is obtained from a plurality of customers as part of retail purchase transactions 122 at a POS system 120 in the defined retail environment 102. A time stamp 128 and a location 126 are included in each retail purchase transaction 122. Customer data 124 can include a name, an address, a member identifier, a loyalty program identifier, a telephone number, or an email address. In some embodiments, customer data 124 is obtained, at least in part, by associating a customer with a cash transaction identifier. In embodiments, the location 126 of the retail purchase transaction 122 includes a POS lane number or a POS system register number.

At 440, sensor data 115 and customer data 124 is received by customer singulation engine 130. The customer singulation engine 130 is configured to singulate at least one of the plurality of customers by matching the time stamp 128 and the location 126 with corresponding sensor data 115 and matching the singulated customer with corresponding received customer data 124.

Some embodiments can also include designating at least one sensor-free zone 119 in the defined retail environment 102. In such a defined retail environment 102, the sensor-free zone 119 and the sensor matrix 110 do not overlap in physical or aerial space. Further, some embodiments can also include aggregating data of singulated customers associated with cash transaction identifiers by customer singulation.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application-specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A customer singulation system for use in a defined retail environment comprising:
a sensor matrix comprising a plurality of fixed sensors arranged in the defined retail environment and at least one mobile sensor configured to move within the defined retail environment, the plurality of fixed sensors and the at least one mobile sensor configured to obtain sensor data by remotely and non-intrusively sensing a common characteristic of a plurality of customers in the defined retail environment;
a point-of-sale (POS) system in the defined retail environment and configured to receive customer data from the plurality of customers as part of the retail purchase transaction, wherein each retail purchase transaction has time stamp and a location; and
a customer singulation engine configured to receive the sensor data and the customer data, singulate at least one of the plurality of customers by matching the time stamp and the location with corresponding sensor data, and match the singulated customer with corresponding received customer data.

2. The system of claim 1, wherein the plurality of fixed sensors and the at least one mobile sensor comprise at least one of optical sensors, infrared sensors, or temperature sensors.

3. The system of claim 2, wherein the common characteristic is at least one of a physical characteristic, an infrared radiation characteristic, or a thermal characteristic.

4. The system of claim 1, wherein the at least one mobile sensor is mounted on an unmanned aerial vehicle.

5. The system of claim 1, further comprising at least one sensor-free zone in the defined retail environment, wherein the sensor-free zone and the sensor matrix do not overlap a physical or aerial space.

6. The system of claim 1, wherein the customer data comprises at least one of a name, an address, a member identifier, a loyalty program identifier, a telephone number, or an email address.

7. The system of claim 1, wherein the customer data comprises a cash transaction identifier.

8. The system of claim 7, wherein the customer singulation engine is configured to aggregate data associated with singulated customers having cash transaction identifiers.

9. The system of claim 1, wherein the plurality of fixed sensors are mounted on any of a floor, a wall, a ceiling or a fixture in the defined retail environment.

10. The system of claim 9, wherein a fixed sensor is mounted proximate to each lane of the POS system, and at least one fixed sensor is mounted proximate to each entrance or exit of the defined retail environment.

11. The system of claim 1, wherein the location of the retail purchase transaction comprises a POS system lane number or a POS system register number.

12. A method of singulating customers in a defined retail environment comprising:
arranging a sensor matrix comprising a plurality of fixed sensors and at least one mobile sensor in the defined retail environment;
obtaining sensor data by the sensor matrix by remotely and non-intrusively sensing a common characteristic of a plurality of customers in the defined retail environment;
obtaining customer data from the plurality of customers as part of retail purchase transactions at a point-of-sale (POS) system in the defined retail environment, each retail purchase transaction comprising a time stamp and a location; and
receiving the sensor data and the customer data by a customer singulation engine configured to singulate at least one of the plurality of customers by matching the time stamp and the location with corresponding sensor data,
and matching the singulated customer with corresponding received customer data.

13. The method of claim 12, wherein the plurality of fixed sensors and the at least one mobile sensor comprise at least one of optical sensors, infrared sensors, or temperature sensors.

14. The method of claim 13, wherein sensing a common characteristic comprises sensing at least one of a physical characteristic, an infrared radiation characteristic, or a thermal characteristic.

15. The method of claim 12, wherein the arranging comprises configuring at least one mobile sensor on an unmanned aerial vehicle.

16. The method of claim 12, further comprising designating at least one sensor-free zone in the defined retail environment, wherein the sensor-free zone and the sensor matrix do not overlap a physical or aerial space.

17. The method of claim 12, wherein obtaining the customer data comprises obtaining at least one of a name, an address, a member identifier, a loyalty program identifier, a telephone number, or an email address.

18. The method of claim 12, wherein obtaining the customer data comprises associating the customer with a cash transaction identifier.

19. The method of claim 18, further comprising aggregating data of singulated customers associated with cash transaction identifiers by the customer singulation.

20. The method of claim 12, wherein arranging comprises mounting the plurality of fixed sensors on any of a floor, a wall, a ceiling or a fixture in the defined retail environment.

21. The method of claim 20, wherein the mounting comprises mounting a fixed sensor proximate to each lane of the POS system, and mounting at least one fixed sensor proximate to each entrance or exit of the defined retail environment.

22. The method of claim 12, wherein the location of the retail purchase transaction comprises a POS system lane number or a POS system register number.
